(19) United States
(12) Patent Application Publication
(10) Pub. No.: US 2010/0332217 A1
(43) Pub. Date: Dec. 30, 2010

(54) Method for text improvement via linguistic abstractions

(76) Inventors: Shalom Wintner, Haifa (IL); Avraham Shpigel, Rishon Lezion (IL); Peter Michael Paz, Haray Yehuda (IL); Daniel Radzinski, Palo Alto, CA (US)

Correspondence Address: Peter Michael Paz, Moshav Neve Ilan 17, Doar Na Haray Yehuda, 90850, IL

(21) Appl. No.: 12/385,931

(22) Filed: Jun. 29, 2009

(51) Int. Cl. G06F 17/27

(52) U.S. Cl. 704/9

(57) ABSTRACT

This invention provides hierarchical, gradual and iterative methods, systems, and software for improving and correcting natural language text. The methods comprise the steps of applying natural language processing (NLP) algorithms to a corpus of sentences so as to abstract each sentence; applying scoring and linguistic annotation to each abstract sentence; applying NLP algorithms to abstract input sentences; applying search algorithms to match an abstract input sentence to at least one abstract corpus sentence; and applying NLP algorithms to adapt said matched abstract corpus sentence to the input sentence.

### CROSS REFERENCE TO RELATED APPLICATIONS

This application claims priority from U.S. Provisional Patent Application No. 61/071,552, filed on May 5, 2008, the contents of which are incorporated herein by reference in their entirety.

### FIELD OF THE INVENTION

The present invention relates to systems, methods and software for text processing and natural language processing. More specifically, the invention relates to methods for text improvement, grammar checking and correction, as well as style checking and correction.

### BACKGROUND OF THE INVENTION

Natural Language Processing (NLP) is the field of computer science that utilizes linguistic and computational linguistic knowledge for developing applications that process natural languages.

A first step in natural language processing is syntactic processing, or parsing. Syntactic processing is important because certain aspects of meaning can be determined only from the underlying sentence or phrase structure and not simply from a linear string of words. A second step in natural language processing is semantic analysis, which involves extracting context-independent aspects of a sentence's meaning.

Natural languages are the naturally-occurring, naturally-developed languages spoken by humans, e.g., English, Chinese, or Arabic. The scientific field of Linguistics investigates natural languages: their structure, usage, acquisition and cognitive representation. Computational Linguistics approaches natural languages from a mathematical-computational point of view.

Natural language text consists of words; morphology is the sub-field of linguistics that investigates the structure of words. A text can be viewed as a sequence of tokens, delimited by white spaces and/or punctuation. A tokenizer is a computer program which splits a text into tokens. Each such token is a possibly inflected form of some lemma, or a lexical item. Syntax is the sub-field of linguistics which investigates the ways in which words combine to form phrases and phrases to form sentences. In particular, syntax defines the grammatical relations that hold among phrases in a given sentence.

Words are classified according to their morphological and syntactic features to grammatical categories, also called parts of speech (POS). A lexicon is a computational database which lists the lemmas of a given language and assigns one or more POS categories to each lemma. Words combine together to form phrases. A phrase consists of a head word and zero or more modifiers, which can be complements or adjuncts. The head word determines the identity of the phrase: for example, a Noun Phrase (NP) is a phrase headed by a noun, a Verb Phrase (VP) is a phrase headed by a verb, etc. Complements are modifiers required by the head word, and without which the head is incomplete. For example, English nouns (e.g., “computer”) require a determiner (e.g., “the”) in order to function as NPs (e.g., “the computer”). Adjuncts are modifiers that add information to the head but are optional. For example, adjectives are adjuncts of nouns, e.g., “the new computer”.

A POS tagger is a computer program which can determine the correct POS category of a given word in the textual context in which the word occurs. A parser is a computer program which can assign syntactic structure to a sentence, and, in particular, determine the grammatical relations that hold among phrases in the sentence. A shallow parser is a computer program which can determine the boundaries of phrases in a sentence, but not the complete structure. A corpus is a computational database that stores examples of language usage in the form of sentences or transcriptions of spoken utterances, possibly with annotations of linguistic information.

A major challenge to NLP is ambiguity: virtually all of the stages involved in language processing can result in more than one output, and the outputs must be ranked according to some goodness measure. For example, a POS tagger selects the best POS for each word in a sentence given its context: there may be several possible assignments of POS for a word. A parser assigns grammatical relations to phrases, but may have to choose from several alternative assignments or structures.

A typical prior art NLP system receives an input text. A tokenizer in the system splits the input text into tokens. A morphological analyzer in the system produces a set of morphological analyses (including POS categories) for each token. A POS tagger ranks the analyses according to at least one goodness or fit measure, based on the surrounding context of the token. A parser in the system assigns a structure to the sentence based on the previous stages of processing. In particular, the structure includes grammatical relations.

Existing approaches to NLP differ in the way they acquire, store and represent linguistic knowledge. Rule-based, analytical approaches typically encode linguistic knowledge manually and specify rules based on such knowledge. Corpus-based, statistical approaches deduce such knowledge implicitly from linguistic corpora. While rule-based approaches can be very accurate, they are limited to the specific rules that were manually encoded by the developer of the application, unless they include some learning adjustment apparatus. Corpus-based approaches are typically less accurate but can have wider coverage since the phenomena they address are only limited by the examples in the corpus: the larger the corpus, the more likely it is that a phenomenon is observed in it. Existing publicly-available corpora currently consist of billions of tokens.

Some commercial tools and prior art patents address grammar and style correction and improvement of text composition. They are typically based on linguistic rules that have to be laboriously encoded and are by their very nature limited to the encoded rules, and specific to a single natural language. Linguistic rules are used both for processing the input sentences and for detecting potential errors in the input. Some methods are based on corpus statistics that reflect grammatical relations between the POS categories of words occurring in a sentence. All existing methods are limited to replacing, removing or adding a single word or phrase, and none of them systematically attempts to suggest full sentence correction or improvement. No prior art method is based on a corpus of sentences from which suggestions of alternative phrases and sentences is computed by abstraction of Noun Phrases (NPs) and other phrases, as proposed in this invention. No prior art method is language-independent.

U.S. Pat. No. 5,642,520 to Kazuo et al., describes a method and apparatus for recognizing the topic structure of language. Language data is divided into simple sentences and a prominent noun portion (PNP) extracted from each. The simple sentences are divided into blocks of data dealing with a single subject. A starting point of at least one topic is detected and a topic introducing region of each topic is determined from block information and language data characteristics. A PNP satisfying a predetermined condition is chosen from the PNPs in each determined topic introduction region as the topic portion (TP) of the topic in the topic introduction region. A topic level indicating a depth of nesting of each topic and a topic scope indicating a region over which the topic continues is determined from the TP and sentences before and after the TP. Sub-topic introduction regions in the remaining area where no topic introduction regions are recognized are determined from block information and language data characteristics. A PNP satisfying a predetermined condition is chosen from the PNPs in each determined sub-topic introduction region as the sub-topic portion (STP) of the sub-topic in the sub-topic introduction region. A temporary topic level indicating a depth of nesting of each sub-topic and a sub-topic scope indicating a region over which the sub-topic continues is determined from the STP and sentences before and after the STP. All determined topics and sub-topics are unified by revising the temporary topic level of each sub-topic according to the topic level of each topic. These topics and their levels are output as a topic structure.

U.S. Pat. No. 7,233,891, to Oh et al., describes a method, computer program product, and apparatus for parsing a sentence which includes tokenizing the words of the sentence and putting them through an iterative inductive processor. The processor has access to at least a first and second set of rules. The rules narrow the possible syntactic interpretations for the words in the sentence. After exhausting application of the first set of rules, the program moves to the second set of rules. The program reiterates back and forth between the sets of rules until no further reductions in the syntactic interpretation can be made. Thereafter, deductive token merging is performed if needed.

U.S. Pat. No. 7,243,305, to Roche et al, describes a system for correcting misspelled words in input text detects a misspelled word in the input text, determines a list of alternative words for the misspelled word, and ranks the list of alternative words based on a context of the input text. In certain embodiments, finite state machines (FSMs) are utilized in the spelling and grammar correction process, storing one or more lexicon FSMs, each of which represents a set of correctly spelled reference words. Storing the lexicon as one or more FSMs facilitates those embodiments of the invention employing a client-server architecture. The input text to be corrected may also be encoded as a FSM, which includes alternative word(s) for word(s) in need of correction along with associated weights. The invention adjusts the weights by taking into account the grammatical context in which the word appears in the input text. In certain embodiments the modification is performed by applying a second FSM to the FSM that was generated for the input text, where the second FSM encodes a grammatically correct sequence of words, thereby generating an additional FSM.

U.S. Pat. No. 7,257,565, to Brill, describes a linguistic disambiguation system and method, which create a knowledge base by training on patterns in strings that contain ambiguity sites. The string patterns are described by a set of reduced regular expressions (RREs) or very reduced regular expressions (VRREs). The knowledge base utilizes the RREs or VRREs to resolve ambiguity based upon the strings in which the ambiguity occurs. The system is trained on a training set, such as a properly labeled corpus. Once trained, the system may then apply the knowledge base to raw input strings that contain ambiguity sites. The system uses the RRE- and VRRE-based knowledge base to disambiguate the sites.

U.S. Pat. No. 7,295,965 describes a method for determining a measure of similarity between natural language sentences for text categorization. There is still a need for methods for evaluating the quality of text based on distance measures between input sentences and corpus sentences. There is a further need for methods devised to assist people with reading disabilities by minimizing text sophistication.

Targeted advertisement placement based on contextual analysis of user query keywords and website contents is well covered in the prior art. There is still an unmet need for methods to be applied to non-browser applications.

### SUMMARY OF THE INVENTION

A method and a system are provided for evaluating the quality of text, identifying grammar and style errors and proposing candidate corrections, thereby improving the quality of said text, by comparing input sentences and paragraphs to a large corpus of text. Matching a given sentence, let alone a larger piece of text, to a corpus of sentences, in order to identify errors and find a correction or improvement, is virtually impossible because the number of natural language sentences is unbounded. To overcome this limitation, this invention proposes to reduce the number of sentences to be considered by abstracting over the internal structure of Noun Phrases (and possibly other types of phrases), replacing words with their synonyms and performing several levels of natural language processing, known in prior art, on both the input sentence and the corpus text. This method results in simpler, shorter sentences that can be efficiently compared. The invention proposes a distance measure between sentences that is used in order to suggest candidate alternatives to sentences that are considered incorrect. The method can be implemented in a computer system.

This method can be applied hierarchically, gradually and recursively. Hierarchical application breaks up a complex sentence to its component clauses and applies the method to each clause independently. Gradual application abstracts over the internal structure of phrases (e.g., NPs, but possibly also other types of phrases) as needed, so that the level of abstraction is gradual, ranging from no abstraction to full abstraction. Through recursive application, the user can select one sentence from the list of candidate improvements suggested by the system as a source sentence on which the method is re-applied, thereby improving the accuracy of the method and providing more alternative suggestions.

The method can automatically, and, with no stipulation of grammar rules, provide various types of corrections and improvements, including detection and correction of spelling errors and typos; wrong agreement; wrong usage of grammatical features such as number, gender, case or tense; wrong selection of prepositions; alternative tense, aspect, voice (active/passive), word- and phrase-order; changes to the style, syntactic complexity and discourse structure of the input text. Since it is not rule-based, it is in principle language-independent and can be used to improve text quality in any natural language, provided an appropriate corpus in that language is given.

User preferences can influence the type of corrections made by a system based on this method. For example, users can determine the genre, style, mood or illocutionary force of the composed text, thereby affecting the candidates proposed by the method.

By setting the parameters that determine the sophistication and syntactic complexity of the proposed alternatives to a minimum value, this method can be used as an application of text simplification, e.g., in assisting people with reading disabilities.

On the other hand, by setting the parameters that determine the sophistication and syntactic complexity of the proposed alternatives to a high value, this method can be used as an application for text embellishment, e.g., in a post-translation context, where text has been initially translated from a source language to a target language and its quality in the target language is later enhanced.

The quality of the source text can be evaluated based on distance measures between an abstraction of the text and abstract sentences in the corpus. Based on text quality, this method can be used in filtering applications, e.g., to filter out low-quality e-mail messages or other types of content.

This method can be used in an application that processes the text given by a user, analyzing keywords by prior art ontology-based methods and providing targeted advertisement to the user, in addition to improving the user's text quality.

This method can be used for translation of sentences from one language to another assuming text corpora and NLP tools in both languages. Sentences are abstracted in the source language; then, their abstract representation is used to search abstracted sentence in the corpus of the target language. A set of rules can be used to convert source language structures to the target language.

There is thus provided according to some embodiments of the present invention, a hierarchical, gradual and iterative method for improving text sentences, the method including the steps of;
a) processing a corpus of sentences so as to form abstracted corpus sentences;
b) abstracting at least one user inputted sentence so as to form at least one abstracted user input sentence; and
c) forming at least one improved user outputted sentence.

According to some embodiments of the present invention, the processing includes at least one of; part of speech tagging, word sense disambiguation, identification of synonyms, identification of grammatical relations, and identification of phrase boundaries.

According to some further embodiments of the present invention, the abstracting includes at least one of; identification of sub-phrases and clauses, substituting wild-cards for each noun phrase (NP), substituting wild-cards for adjunct words and phrases, identification of synonyms for words, and combinations thereof.

Further, according to some embodiments of the present invention, the processing consists of handling sentence sub-phrases separately as standalone clauses.

Yet further, according to some embodiments of the present invention, the processing includes partial abstraction of at least one phrase, full abstraction of at least one phrase; abstracting of at least one word by replacing the words with corresponding synonym sets; and breaking up at least one phrase to sub-phrases; and combinations thereof.

Additionally, according to some embodiments of the present invention, the processing includes applying the improvement method to sentences which have previously been improved.

Moreover, according to some embodiments of the present invention, the processing a corpus of sentences includes scoring of each abstract sentence by at least one of; frequency scoring of the abstract sentence, confidence scoring based on at least one confidence level of an NLP tool.

According to some embodiments of the present invention, the processing a corpus of sentences includes linguistic annotation including associating an abstracted sentence with a set of linguistic properties.

Additionally, according to some embodiments of the present invention, the linguistic properties include at least one of; tense, voice, register, polarity, sentiment, writing style, domain, genre, syntactic sophistication, and combinations thereof.

According to some additional embodiments of the present invention, the forming an improved user outputted sentence includes searching for at least one corpus abstracted sentence that is matched to the user inputted abstracted sentence.

Further, according to some embodiments of the present invention, the searching step includes at least one of; maximizing compatibility with preferences of a user, minimizing changes between the abstracted input sentence and the abstracted corpus sentence, maximizing a score of abstracted sentences, maximizing a confidence level of the linguistic processing, and combinations thereof.

Yet further, according to some embodiments of the present invention, the forming at least one improved user outputted sentence includes adaptation of the abstracted corpus sentence to the user inputted sentence, wherein the adaptation includes at least one of; replacing each wild-card noun phrase (NP) with concrete NPs from the inputted sentence, adapting a grammatical structure of a resulting sentence, replacing and adapting adjuncts, and reconstructing source sentence sub-phrases.

According to some embodiments of the present invention, the adaptation of wild-card NPs includes the steps of;
a) abstracting out-of-vocabulary words and phrases;
b) selecting NPs from a corpus based on frequency;
c) restoring abstracted out-of-vocabulary words or phrases; and
d) adapting NP properties.

Moreover, according to some embodiments of the present invention, adapting adjuncts is based on grammatical relations in the user inputted sentence.

According to some embodiments of the present invention, the corpus includes at least one of a corpus on a local PC, an organizational private corpus, and a remote network corpus on a remote server.

Additionally, according to some embodiments of the present invention, the user inputted sentence includes at least one of a sentence in at least one document, a sentence in an email message, a sentence in a blog text, a sentence in a web page, and a sentence in any electronic text form.

According to some embodiments of the present invention, the method is adapted to help people with reading disabilities by improving a source text wherein a syntactic sophistication is minimized.

Further, according to some embodiments of the present invention, the method further includes text evaluation, based upon counting a number of corrections required by improving source text using pre-defined parameter settings.

According to some additional embodiments of the present invention, the method further includes ontology-based advertising enabled by at least one of the following steps;
a) improving an input sentence;
b) using input sentence elements as keywords and key phrases; and
c) displaying relevant advertising to a user.

There is thus provided according to some further embodiments of the present invention, a computer software product for improving text sentences, including a computer-readable medium in which program instructions are stored, which instructions, when read by a computer, cause the computer to;
a) process a corpus of sentences so as to form abstracted corpus sentences;
b) abstract at least one user inputted sentence so as to form at least one abstracted user input sentence; and
c) form at least one improved user outputted sentence.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified pictorial illustration of a system for text improvement, in accordance with an embodiment of the present invention;

FIG. 2A is a simplified flow chart of a method for offline processing of a corpus, in accordance with an embodiment of the present invention;

FIG. 2B is a simplified flow chart of a method for abstracting of sentences, in accordance with an embodiment of the present invention;

FIG. 2C is a simplified flow chart of a method for scoring and annotating an abstracted sentence, in accordance with an embodiment of the present invention;

FIG. 2D is a simplified flow chart of a method for associating and scoring linguistic properties with a sentence, in accordance with an embodiment of the present invention;

FIG. 3A is a simplified flow chart of a method for improving sentences, in accordance with an embodiment of the present invention;

FIG. 3B is a simplified flow chart of a method for matching criteria, in accordance with an embodiment of the present invention;

FIG. 3C is a simplified flow chart of a method for post-processing of abstract sentences, in accordance with an embodiment of the present invention;

FIG. 3D is a simplified flow chart of a method for adaptation of input noun phrases, in accordance with an embodiment of the present invention;

FIG. 4 is a simplified flow chart of a method for iterative text improvement, in accordance with an embodiment of the present invention;

FIG. 5 is a simplified flow chart of a method for assisting people with reading disabilities, in accordance with an embodiment of the present invention;

FIG. 6 is a simplified flow chart of a method for text evaluation, in accordance with an embodiment of the present invention;

FIG. 7 is a simplified flow chart of a method for filtering texts, in accordance with an embodiment of the present invention; and

FIG. 8 is a simplified flow chart of a method for ontology-based advertising, in accordance with an embodiment of the present invention;

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention describes systems, methods and software for text processing and natural language processing. More specifically, the invention describes methods for text improvement, grammar checking and correction, as well as style checking and correction. The method of text improvement has applications for text editing and composition, evaluation of text quality, document filtering, based on text quality, assistance to individuals with reading disabilities, text translation, and targeted on-line advertising.

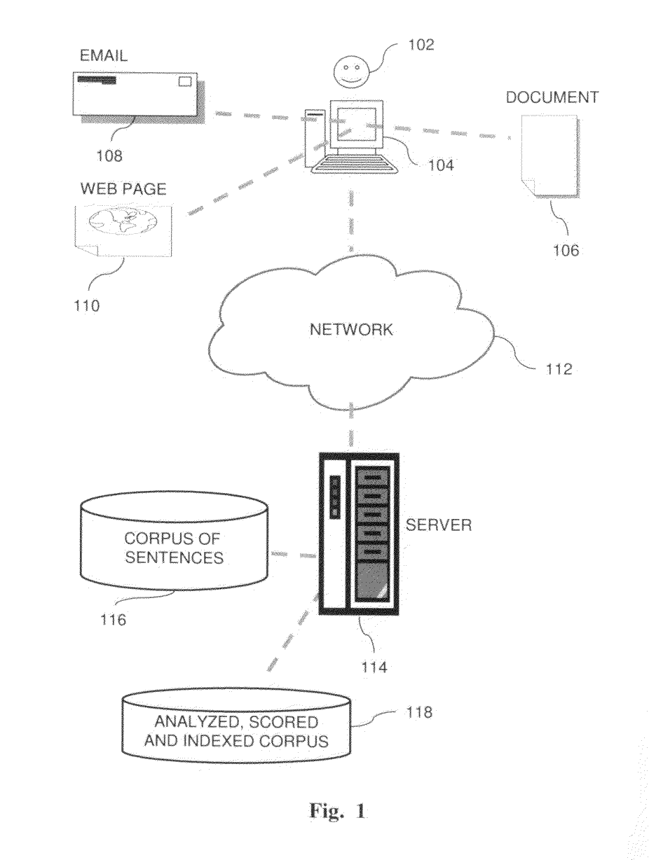

Reference is now made to FIG. 1 which is a schematic pictorial illustration of a computer system to improve text, comprising a personal computer (PC) 104 and a User 102 using the PC to write a document 106, an email message 108 or a web page 110. The PC 104 is connected to a server 114 via a network 112. The server 114 has access to a corpus of natural language sentences 116 and a corpus of the same sentences, analyzed by various NLP techniques, scored, annotated and indexed 118.

The network 112 represents any communication link between the PC 104 and the server 114 such as the Internet, a cellular network, an organizational network, a wired telephone network, etc.

The server system 114 is configured according to the invention to carry out the methods described herein for providing the user 102 with improved sentences.

While editing a piece of text, the user 102 can mark a sentence to be improved. The marked sentence is transferred to the server 114, which searches for one or more candidate improved sentences that are the most fitting to the user predefined preferences. The list of improved sentences is presented to the user 102. By selecting one of the candidate improved sentences the user can iteratively improve it again and again.

The location of the corpus 116 and the analyzed corpus 118 is not limited to a remote network. They can reside on the PC 104 or on an additional computer (not shown) connected directly to PC 104.

The invention is not limited only to PC 104. Any text editing appliance, including but not limited to mobile phones or hand-held devices, can be used.

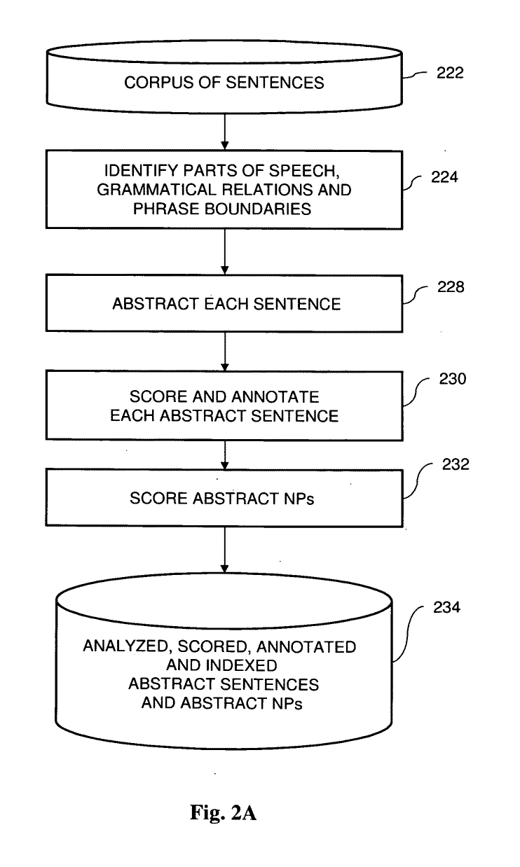

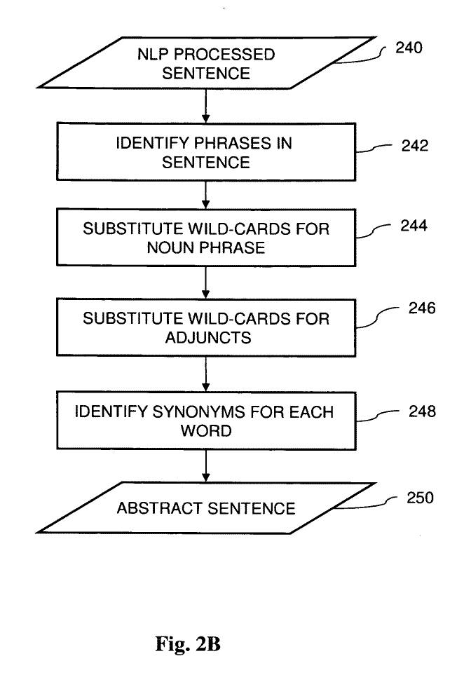

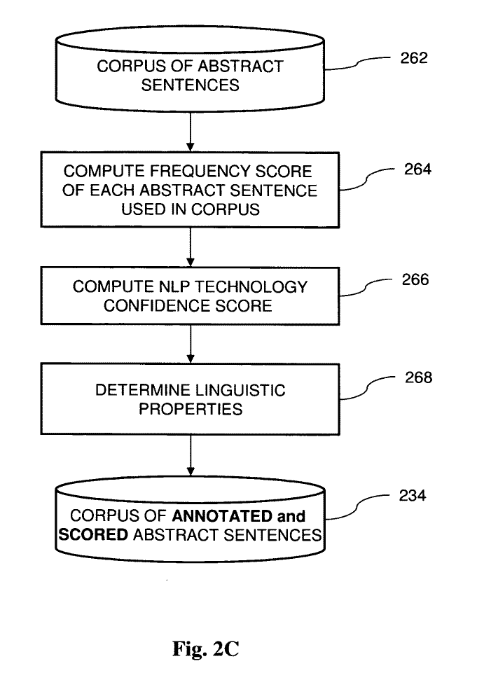

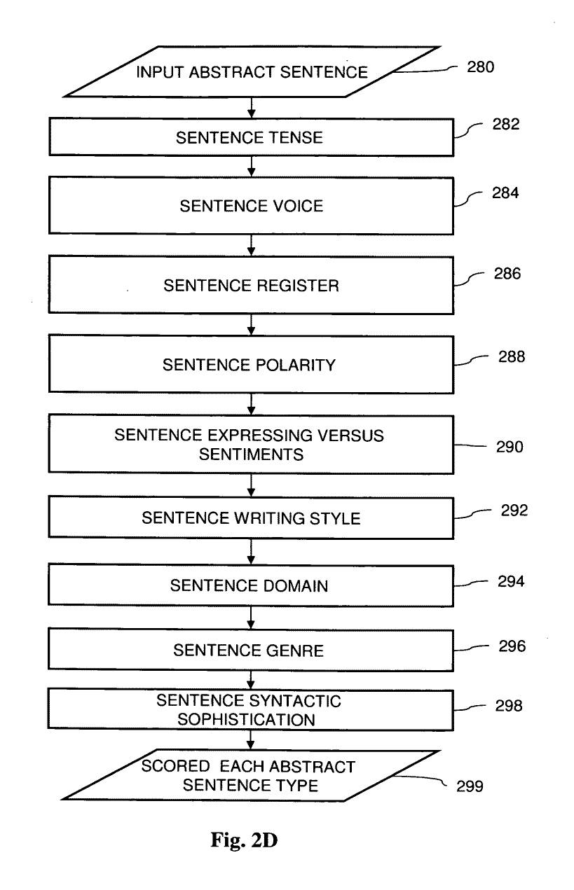

Reference is now made to FIG. 2A which relates to the offline processing and the preparation of the corpus of sentences 222 for the next step of matching. Prior art NLP tools are applied to each sentence in the corpus 222, to identify parts of speech, grammatical relations and phrase boundaries 224. In cases of ambiguity, one or more results of applying NLP tools can be used. Then, each sentence is gradually abstracted 228 as described in FIG. 2B. The abstracted sentences are then scored and annotated 230 as described in FIG. 2C. Then, the NPs which occur in the input sentence are scored according to their frequency in the corpus 232. The analyzed and scored abstract sentences and NPs are indexed using prior art methods to facilitate efficient retrieval and matching of users' input abstract sentences against the corpus sentences 234. Indexing using prior art utilizes DB technology (e.g., SQL) for efficient retrieval of information, making use of keywords and/or logical connectives. It is outside the scope of this invention to discuss optimization methods used in large DBs for fast information retrieval.

Reference is now made to FIG. 2B which describes the steps to abstract a sentence. Some of the abstraction steps 242-248 can be used in some cases and some in other cases; various orders of steps 242-248 are conceivable. Given an input sentence processed by prior art NLP tools 240, the phrases (including sub-sentences) which make up the sentence are identified 242 using prior art methods. Each identified Noun Phrase (NP) is replaced with a wild-card 244 to indicate that its internal structure is abstracted over (i.e., abstraction). Adjuncts (such as adverbs) are replaced by wild-cards 246. Words are replaced by their sets of synonyms in the abstract sentence 248 using prior art methods. The resulting abstract sentence 250 is likely to have a basic structure identical to other abstract sentences in the corpus.

Breaking up of sentences to component clauses 242 is used to hierarchically partition sentences, thereby facilitating improvement of each clause separately as a stand-alone sentence. The improved clauses are combined when presenting the improved sentence to the user.

The abstraction steps 242-248 in FIG. 2B can be done completely or partially. The number of NPs to be abstracted 244 can range from zero to the number of NPs in the sentence; of those NPs that are abstracted, the full NP can be abstracted, or parts thereof. Zero or more adjuncts can be abstracted 246; zero or more words can be replaced by their synonym sets 248; and zero or more phrases can be broken up to sub-phrases 242.

Reference is now made to FIG. 2C. After sentences are abstracted 262 they are associated with two scores. The frequency score 264 of a sentence is a function of the frequency of its abstract structure in the corpus. The confidence score 266 of a sentence is a function of the confidence level of the prior art NLP tools used to determine the sentence structure. These two scores are used by the distance measure that determines the distance between an input sentence and an existing corpus sentence. Additionally, the sentence is associated with a number of linguistic features 268 as detailed in FIG. 2D.

Reference is now made to FIG. 2D. The input sentence is associated with various linguistic properties using prior or future art tools and methods. These properties include but are not limited to sentence tense 282, voice (i.e., Passive or Active) 284, sentence register (i.e., formal, informal, colloquial) 286, sentence polarity (positive or negative) 288, sentiment (e.g., assertive, apologetic) 290, writing style 292, domain 294, genre 296 and syntactic sophistication 298. These properties can be computed in any order using a variety of implementations. These properties can be used to match an input sentence against corpus sentences according to the user preferences.

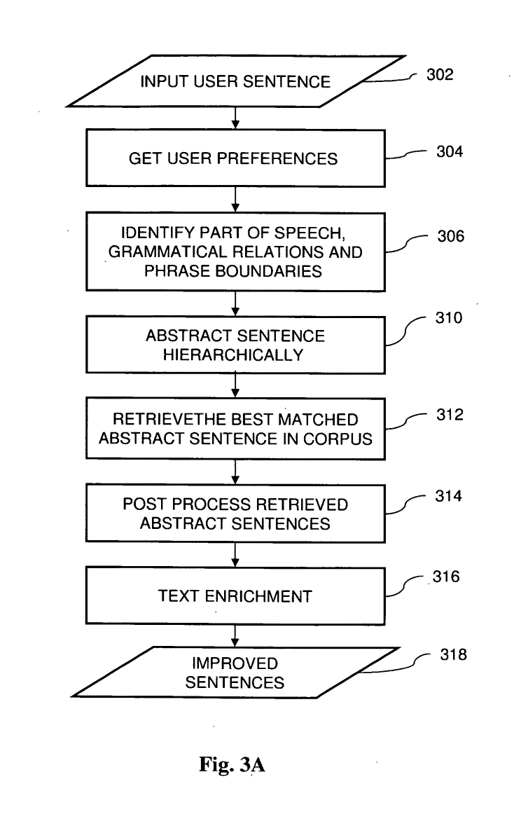

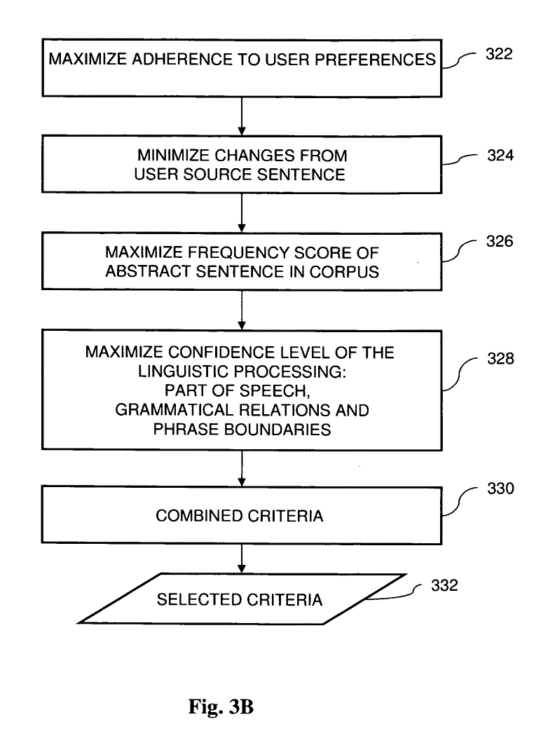

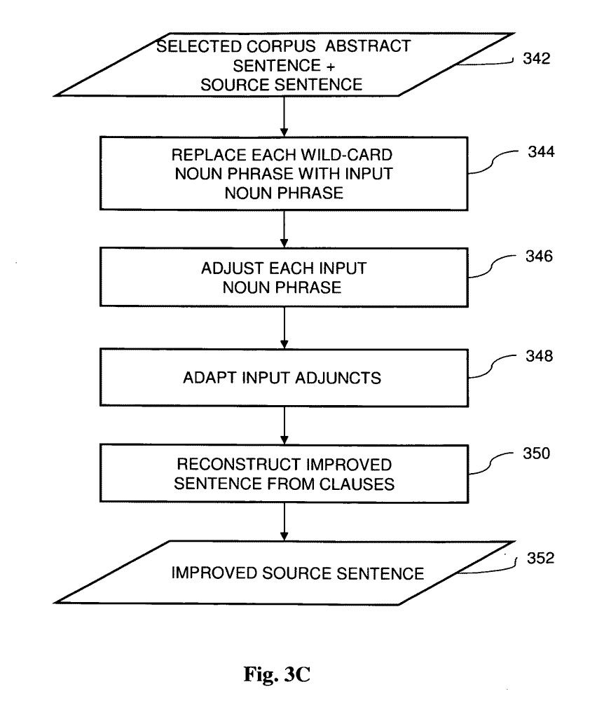

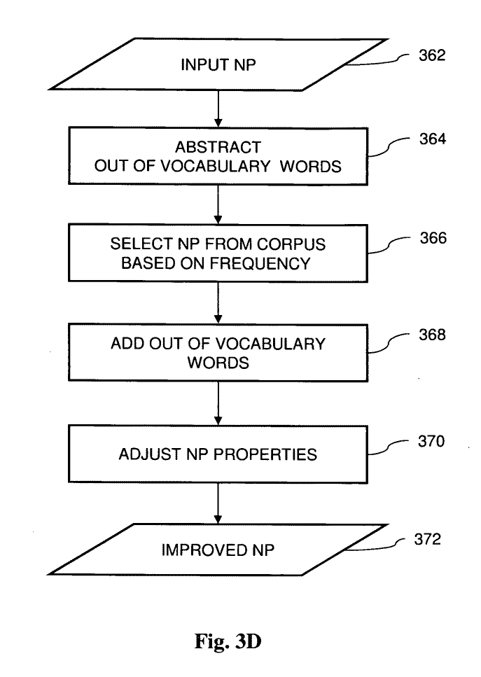

Reference is now made to FIG. 3A, which describes the basic steps to improve a user input sentence 302. The User can select several personal preferences 304 based upon the linguistic properties detailed in FIG. 2D 282-228. Prior art NLP tools are applied to each sentence to identify part of speech, grammatical relations and phrase boundaries 306. In cases of ambiguity, one or more analyses can be performed. The input sentence is abstracted 310 as in FIG. 2B. The abstract input sentence is then matched against the stored abstract corpus sentences, and the best matches are selected. The criteria for the matching 312 are fully detailed in FIG. 3B. Post processing 314 is performed on the retrieved sentence and the input sentence according to FIG. 3C.

Depending on the User's preferences, the improved sentences can undergo text enrichment 316. Text enrichment includes, but is not limited to, adding adjuncts (e.g., modifying nouns by adjectives, or modifying verb phrases by adverbs). This stage results in several improved sentences 318 which are then displayed to the User. The User is provided with an ordered list of candidate improved sentences; the list order will reflect the score of the corpus sentences and the degree of adherence to the User preferences.

Reference is now made to FIG. 3B, which describes the criteria 332 that can be used to match an abstracted input sentence against abstracted corpus sentences: 1) maximize compatibility with the User preferences 322 2) minimize changes between the corpus abstract sentence and the input abstract sentence 324 3) maximize corpus sentence frequency score 326 4) maximize corpus sentence confidence score 328. Any of these criteria 322-328 can be used, and the criteria can be computed in any order. Also, a weighted combination 330 of any of the criteria can be used, with different weights assigned to each criterion.

Reference is now made to FIG. 3C which describes the post processing of the selected corpus abstract sentences, taking into account the input sentence 342. First, the abstracted NPs in the candidate corpus abstract sentence are replaced with the input sentence NPs 344. Then, each NP is adjusted to the new sentence structure 346 as is fully detailed in FIG. 3D. Then, the input adjuncts (e.g., adverbs) 348 are adapted to the new sentence structure based on the linguistic analysis detailed in 306 in FIG. 3A. Then, clauses of the source sentence are combined again 350 to re-create a full, improved sentence 352.

Reference is now made to FIG. 3D, which describes the adaptation and improvement of input NPs 362, taking into account a candidate abstract sentence selected from the corpus. First, out of vocabulary words (in particular, proper names) in the input sentence are replaced by wild cards 364. Then, the most frequent abstract NP in the corpus that best matches the input NP is selected 366. Then, the out of vocabulary words of the input NP are substituted for the wild cards in the abstract NP 368. Then, the grammatical features of the NP (number, gender, case, etc.) are adjusted 370 resulting in an improved NP 372.

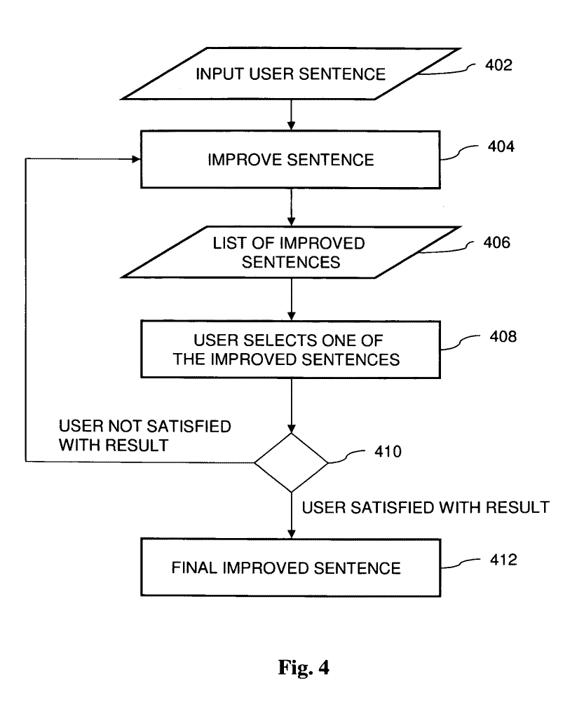

Reference is now made to FIG. 4, which describes an iterative way to improve the User's source sentence 402. The basic improvement process is used 404 (as described in FIG. 3A) resulting in a list of candidate improved sentences 406. It is assumed that most users will select the top-ranked improved sentence. However, users may select any sentence 408 which can then be used as a new source sentence, to which the improvement method is recursively applied 410 yielding a new result set. This iterative process can be repeated indefinitely until the user is satisfied with one of the improved sentences 412.

While in the iterative improvement loop 410 the user preferences 304 can also be changed.

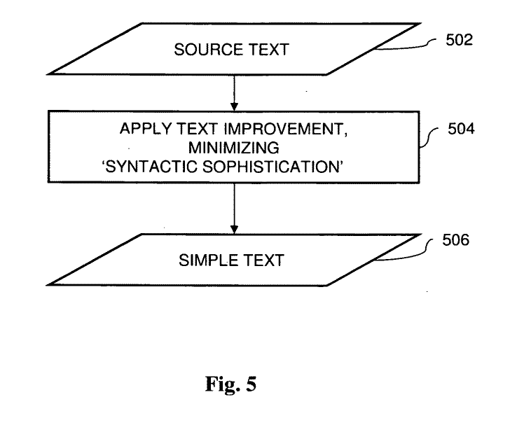

Reference is now made to FIG. 5, which describes an application that assists individuals with reading disabilities, based on the sentence improvement method proposed in this invention. Given a source text, each sentence in the text 502 is converted to text as described in FIG. 3A, where the user preferences are selected automatically to a pre-defined combination that minimizes syntactic sophistication 504, resulting in a simplified text 506 that carries the same meaning as the original text, but is easier for individuals with reading disabilities to comprehend.

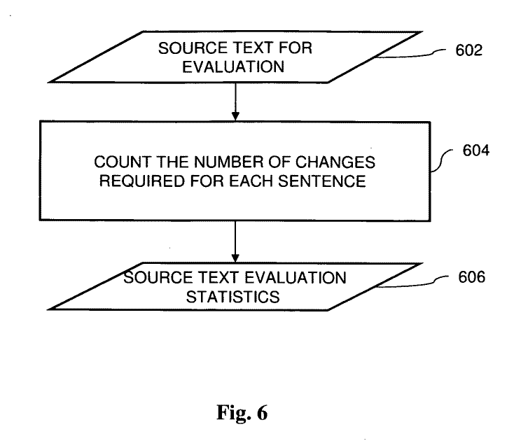

Reference is now made to FIG. 6, which describes an application to evaluate the quality of input text 602. Given a source text, each sentence in the text 602 is converted to text as described in FIG. 3A, where the user preferences are selected automatically to a pre-defined combination that minimizes changes. The number of changes introduced in the text is counted 604. The fewer the changes, the better the quality of the input text is 606.

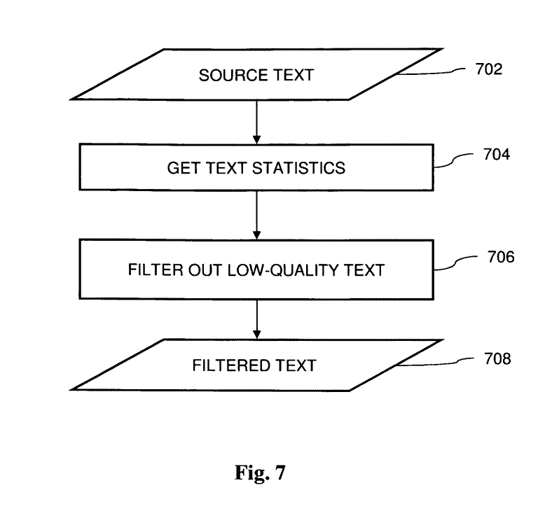

Reference is now made to FIG. 7, which describes an application to filter 706 low-quality texts 702 yielding filtered texts 708. The method to get text statistics 704 (as detailed in FIG. 6) can be used to determine the quality of input text. An application can then filter out texts 706 whose quality is below a given threshold. This method can be used to filter e-mail messages, blog texts or any other kind of text.

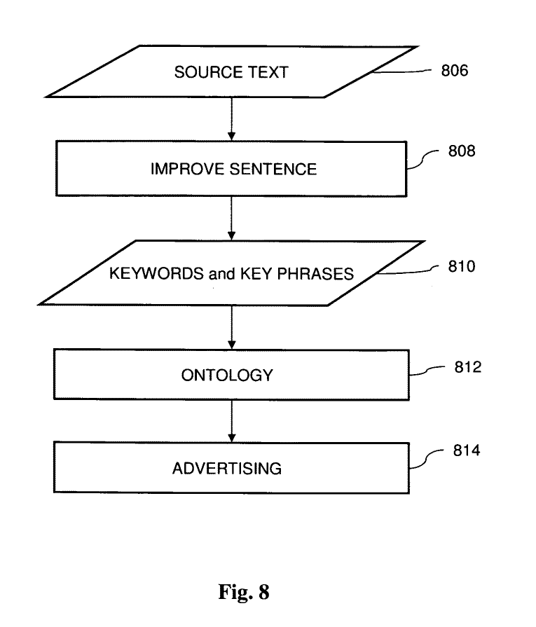

Reference is now made to FIG. 8, which describes a method for advertising in browser and in non-browser PC applications, based on keywords and key phrases extracted from an input text 806 that was sent from the PC 104 to the server 114 for text improvement. In addition to the improved sentence 808 available to the PC User 102, elements of the analyzed text 810 (e.g., NPs) are transferred to prior art targeted advertising 812 to extract the User's 102 areas of interest, which are then used to send targeted advertising 814 to the PC User 102.

### EXAMPLES

### Example 1

### Linguistic Processing of Text

Input text: “it's almost time for lunch.”

Tokenization output: <it, 's, almost, time, for, lunch,.>

Morphological analysis, listing the possible POS of each token:
it: pronoun; expletive
's: verb; possessive
time: noun; verb
almost: adverb
for: preposition
lunch: noun; verb

POS tagging ranks the analyses; in the example above, the first POS is the correct one in the context.

Phrase boundaries:

[[it]['s almost][time[for[lunch]]]

Phrase boundaries with phrase types:

[[NP it][VP 's almost][NP time[PP for[NP lunch]]]
Additional prior art syntactic processing can identify grammatical relations such as SUBJECT and OBJECT, if such grammatical relations should be required.

### Example 2

### NP Abstraction

Given the sentence “it's almost time for lunch”, a possible abstraction consists of replacing all noun phrases by wildcards. This results in:

[NP *][VP's almost][NP *[PP for[NP*]]]

Another possibility is to abstract only the last NP, resulting in:

[[NP it][VP's almost][NP time[PP for[NP*]]]

Observe also that the completely different sentence “the ones in the corner are packages for shipping” results in a very similar abstract structure:

[[NP the ones[PP in[NP the corner]]][VP are][NP packages[PP for[NP shipping]]]

[[NP *][VP are][NP * [PP for[NP *]]]

### Example 3

### Text Improvement

Assume the following input: “its almost time to dinner”. Note the wrong “its” where “it's” is required, and the incorrect use of the preposition. Once abstracted, it may yield the following structure:

[NP *][VP][NP *[PP for[NP *]]]

Matching against a corpus of processed abstract sentences may reveal that the closest match is a similar structure, where the VP is either “is” or “are”, and where the first NP is a pronoun (e.g., “it”). Also, in such structures the preposition “for” may be much more frequent than “to”. Hence, the system may propose the following correction: “it is time for dinner”.

### Example 4

Assume that the following sentence is given in the corpus:

“The search and recommendation system operates in the context of a shared bookmark manager, which stores individual users' bookmarks (some of which may be published or shared for group use on a centralized bookmark database connected to the Internet).”

With partial abstraction, the following can be obtained:

[NP The search and recommendation system] operates in the context of [NP a shared bookmark manager], which stores [NP individual users' bookmarks] (some of which may be published or shared for group use) on [NP a centralized bookmark database] connected to the [NP Internet].

Now assume the following input:
“The system operates in the context of a multi-user platform, who stores information on a distributed database connected with Internet”
Once abstracted (partially), this can be represented as:

[NP The system] operates in the context of [NP a multi-user platform, who stores [NP information] on [NP a distributed database] connected with [NP Internet]

The method then searches for close matches to the following abstract structure:

[NP] operates in the context of [NP] who stores [NP] on [NP] connected with [NP]

One of the possibilities retrieved, based on the example corpus sentence, is:

[NP] operates in the context of [NP] which stores [NP] (PARENTHETICAL) on [NP] connected to the [NP].

From which the following correction is proposed:

“The system operates in the context of a multi-user platform, which stores information on a distributed database connected to the Internet.”

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

### List of Abbreviations

DB Database
NLP Natural Language Processing
NP Noun Phrase
PC Personal Computer
POS Part Of Speech
SQL Structured Query Language
SYN Synonyms
WC Wild-Card or *

What is claimed is:

1. A hierarchical, gradual and iterative method for improving text sentences, the method comprising the steps of:
a) processing a corpus of sentences so as to form abstracted corpus sentences;
b) abstracting at least one user inputted sentence so as to form at least one abstracted user input sentence; and
c) forming at least one improved user outputted sentence.

2. A method according to claim 1, wherein said processing comprises at least one of: part of speech tagging, word sense disambiguation, identification of synonyms, identification of grammatical relations, and identification of phrase boundaries.

3. A method according to claim 1, wherein said abstracting comprises at least one of: identification of sub-phrases and clauses, substituting wild-cards for each noun phrase (NP), substituting wild-cards for adjunct words and phrases, identification of synonyms for words, and combinations thereof.

4. A method according to claim 1, wherein said processing consists of handling sentence sub-phrases separately as standalone clauses.

5. A method according to claim 1, wherein said processing comprises partial abstraction of at least one phrase, full abstraction of at least one phrase; abstracting of at least one word by replacing said words with corresponding synonym sets; and breaking up at least one phrase to sub-phrases; and combinations thereof.

6. A method according to claim 1, wherein said processing comprises applying said improvement method to sentences which have previously been improved.

7. A method according to claim 1, wherein said processing a corpus of sentences comprises scoring of each abstract sentence by at least one of: frequency scoring of the abstract sentence, confidence scoring based on at least one confidence level of an NLP tool.

8. A method according to claim 1, wherein said processing a corpus of sentences comprises linguistic annotation comprising associating an abstracted sentence with a set of linguistic properties.

9. A method according to claim 8, wherein said linguistic properties comprise at least one of: tense, voice, register, polarity, sentiment, writing style, domain, genre, syntactic sophistication, and combinations thereof.

10. A method according to claim 1, wherein said forming an improved user outputted sentence comprises searching for at least one corpus abstracted sentence that is matched to said user inputted abstracted sentence.

11. A method according to claim 10, wherein said searching step comprises at least one of: maximizing compatibility with preferences of a user, minimizing changes between the abstracted input sentence and the abstracted corpus sentence, maximizing a score of abstracted sentences, maximizing a confidence level of the linguistic processing, and combinations thereof.

12. A method according to claim 1, wherein said forming at least one improved user outputted sentence comprises adaptation of said abstracted corpus sentence to said user inputted sentence, wherein said adaptation comprises at least one of: replacing each wild-card noun phrase (NP) with concrete NPs from said inputted sentence, adapting a grammatical structure of a resulting sentence, replacing and adapting adjuncts, and reconstructing source sentence sub-phrases.

13. A method according to claim 12, wherein said adaptation of wild-card NPs comprises the steps of:
a) abstracting out-of-vocabulary words and phrases;
b) selecting NPs from a corpus based on frequency;
c) restoring abstracted out-of-vocabulary words or phrases; and
d) adapting NP properties.

14. A method according to claim 12, wherein adapting adjuncts is based on grammatical relations in the user inputted sentence.

15. A method according to claim 1, wherein said corpus comprises at least one of a corpus on a local PC, an organizational private corpus, and a remote network corpus on a remote server.

16. A method according to claim 1, wherein said user inputted sentence comprises at least one of a sentence in at least one document, a sentence in an email message, a sentence in a blog text, a sentence in a web page, and a sentence in any electronic text form.

17. A method according to claim 1, wherein said method is adapted to help people with reading disabilities by improving a source text wherein a syntactic sophistication is minimized.

18. A method according to claim 1, further comprising text evaluation, based upon counting a number of corrections required by improving source text using pre-defined parameter settings.

19. A method according to claim 1, further comprising ontology-based advertising enabled by at least one of the following steps:
a) improving an input sentence;
b) using input sentence elements as keywords and key phrases; and
c) displaying relevant advertising to a user.

20. A computer software product for improving text sentences, comprising a computer-readable medium in which program instructions are stored, which instructions, when read by a computer, cause the computer to:
a) process a corpus of sentences so as to form abstracted corpus sentences;
b) abstract at least one user inputted sentence so as to form at least one abstracted user input sentence; and
c) form at least one improved user outputted sentence.
